(19) United States
(12) Patent Application Publication
(10) Pub. No.: US 2008/0135408 A1
(43) Pub. Date: Jun. 12, 2008

(54) Manufacturing Process For Producing Narrow Sensors

(75) Inventor: Annika Lindgren Sjolander, Trelleborg (SE)

Correspondence Address: NOVO NORDISK, INC.;INTELLECTUAL PROPERTY DEPARTMENT, 100 COLLEGE ROAD WEST, PRINCETON, NJ, 08540, US

(73) Assignee: Novo Nordisk A/S, Bagsvaerd (DK)

(21) Appl. No.: 11/660,720

(22) PCT Filed: Aug. 18, 2005
(86) PCT No.: PCT/EP05/54090

§ 371 Date: Nov. 28, 2007

(30) Foreign Application Priority Data
Aug. 20, 2004 (DK) PA 2004 01265

(51) Int. Cl. G01N 27/30; B05D 5/12

(52) U.S. Cl. 204/403.01; 427/77

(57) ABSTRACT

This application relates to electrode assemblies (100) for use in an electrochemical sensor, the electrode assembly comprising: a first conductive layer (2) comprising a first electrode surface (8) and a first contact area (11), a second conductive layer (4) comprising a second electrode surface (9) and a second contact area (12), and a first dielectric layer (3) where said first dielectric layer is adjacent to said first conductive layer, wherein said second conductive layer and said first dielectric layer do not cover at least a part of the first and at least a part of the second electrode surface and do not cover at least a part of the first and at least a part of the second contact area. It also relates to methods of manufacturing such electrode assemblies. In this way, modification of conventional 2D structures into sandwiched or 3D structures containing at least two separated conductive layers is provided by a sequential application of further layers constituting at least one dielectric layer and one further conducting layer to the original 2D structure. The dielectric layer may be applied first, followed by the application of a further electrical conducting layer. Alternatively the conventional 2D layer may be modified by lamination of a further 2D layer, thus forming a sandwiched structure.

### FIELD OF INVENTION

This invention relates to the production of electrode assemblies suitable for use in electrochemical sensors, in particular transcutaneous electrochemical sensors suitable for in vivo measurement of metabolites.

### BACKGROUND OF THE INVENTION

In recent years, a variety of electrochemical sensors have been developed for in vivo measurements of metabolites. Most prominent among these glucose sensors have been developed for use in obtaining an indication of blood glucose (BG) levels in a diabetic patient. BG information is of the utmost importance to diabetics, as these readings are instrumental in the adjustment of the treatment regimen. The conventional way to obtain BG information is applying minute amounts of blood to test strips. A new development is transcutaneous sensors where the sensor is implanted under the skin. As the sensor is in contact with biological fluids for a prolonged period of time the possibility for continuous measurements is opened. Continuous BG readings obtained with little or no delay is particularly useful in numerous ways. First of all the continuous monitoring will help preventing hypoglycaemic incidents and thus contribute to a vast increase in the quality of life for the diabetic patient. Furthermore continuous BG readings may e.g. be used in conjunction with semi automated medication infusion pumps of the external type or automated implantable medication infusion pumps, as generally described in U.S. Pat. Nos. U.S. Pat. No. 3,837,339, U.S. Pat. No. 4,245,634 and U.S. Pat. No. 4,515,584. This will allow the patient having a near normal lifestyle, thus eliminating or greatly minimizing the problems normally associated with diabetes.

The sensors utilised for BG measurements can be made in a number of different ways. In the simplest form the sensor is made by two separate electrodes placed transcutaneously, near each other. The two electrodes typically designated working electrode (WE) and reference electrode (RE) serve different purposes, respectively.

The function of the working electrode (WE) is to detect the metabolite of interest, thus this electrode is often covered with an enzyme and/or a catalytic coating to facilitate creation of charge due to reduction or oxidation of the metabolite of interest.

The function of the reference electrode (RE) is to have a constant potential. In an amperometric system a fixed potential difference is applied between the working electrode and the reference electrode. This potential drives the electrochemical reaction at the working electrode's surface.

When a more controlled applied potential on the WE or a longer RE lifetime is needed a so called three-electrode system is used instead. In this slightly more complicated setup, the RE of the two-electrode system is substituted with two electrodes, a reference electrode (RE) and a counter electrode (CE). The CE is responsible for the transfer of the current and the RE's only function is to act as a reference point for the applied potential. The differences between two- and three-electrode systems are outside the scope of this application and in the following all references are made to a three-electrode system unless anything else is specifically mentioned.

If used for clinical purposes it is clearly not convenient to implant several electrodes near each other, thus the electrodes are assembled in one unit defining an electrode assembly or electrode array (forth simply denoted electrode assembly or assembly). An electrode assembly comprises at least the three (or at least the two) electrodes mentioned above WE, RE and CE (or WE and RE) but can additionally contain electrodes for temperature measurements, differential measurements or other purposes.

Different strategies exist for production of electrode assemblies, e.g. as described in Urban and Jobst, in D. M. Fraser (Ed), Biosensors in the body, John Wiley & Sons, Chichester, UK, 1997, p. 197-216. One common used strategy is to dispose electrical conducting tracks on flexible foils made by a dielectric material. Several methods exist for deposition of conducting tracks, including printing, etching of conducting layers covering the flexible foils or by direct vacuum plating of conducting structures. The conventional technologies have in common that the conducting material is deposited in a 2D pattern (see e.g. FIG. 4, which will be explained later). The method involves either (I) (see e.g. Fiaccabrino and Koudelka-Hep, Electroanalysis 10 (1998) 217-222) the steps of first applying a conducting layer (thin-film technology, sputtering, electroplating, screen printing etc.) onto a dielectric substrate foil and then partial removal of layer (etching, laser ablation etc.) to generate the pattern; or (II) the step of applying metal/metals in a pattern/patterns (screen printing, ink jet printing etc.) onto a dielectric substrate foil. I.e. in method (I) the material that is not wanted is removed and in method (II) only the wanted material is added.

Screen printing or thick film technology has normally been used since the 1950s for the production of hybrid circuits in the electronics industry. Thick film devices consist of one or more layers of material on a dielectric substrate, which are conventionally deposited by screen printing (Albareda-Sirvent et al, Sensors and Actuators B, 69 (2000) 153-163). Screen printing is performed by pressing paste through a screen (e.g. formed by a woven screen or a metal mask, having the layout of the desired device) by means of a moving rubber squeegee. The squeegee brings the screen into contact with the substrate surface dependent on screen tension and squeegee pressure, hardness and speed. The paste remaining in the screen aperture is then transferred to the substrate resulting in the desired layout. After deposition of the pattern onto the dielectric substrate the paste is cured by temperature rise to remove solvents and allow tight fusion to the substrate alternatively by UV light exposure.

Common for most electrode assemblies is that electrical contact is preferred at the two ends of each conductor track. The conductor tracks are covered with a layer of insulating material (dielectric). At one end of the conductor track, an area remains naked such that contact can be established to the supporting electrical circuits; such an end is in the following designated CPE (contact pad for electronics). At the other end, an area is also left naked and serves as the electrode surface; this end is in the following designated ES (electrode surface).

A limited number of conductive materials can be used in method (I) above, thus the ES might be plated with the desired metal before or after the insulating material is applied on the conductor tracks.

U.S. Pat. No. 6,103,033 teaches how an electrode assembly may be produced using a printing technique.

A problem with the present 2D technologies is that if the sensor should be narrow, the conductors down to the electrode areas will take up valuable space on the limited area, see e.g. FIG. 4, which will be explained later.

Additionally, while conventional printing techniques using normal 2D techniques typically offer simple and efficient production of electrodes, it is often a problem to print very fine structures using conventional printing techniques using high viscous printing paste. Generally, the finer structures (typically below 100 μm line space definition) that can be printed, the more complicated and expensive technique is needed for manufacturing. As an example, in order to obtain a line space definition in a range about 20 μm, expensive photolithography with sputter deposition manufacturing is needed.

Although the dimensions that can be realised with printing are not as small as with thin-film technology, the ease of use printing technology is very attractive for the production of in-vitro sensors, where the over-all size of the electrode assembly is not a problem and hence the limited capability for printing small structures is in general not recognized.

However, if the electrode assembly is made for an implantable sensor then size will be of great importance since implantation of large sensors will result in a high level of tissue damage as well as a possible formation of scar tissue. Furthermore, implantation will result in unacceptable pain during insertion. It is therefore highly desirable to reduce the width of the sensor and hence the problems related to implantation.

Patent specification U.S. Pat. No. 6,103,033 teaches one viable strategy for reducing the width of the electrode assembly. According to U.S. Pat. No. 6,103,033 an electrode assembly can be produced by printing on both sides of a dielectric foil. Although this might potentially reduce the width of a two-electrode assembly to half width, the width reduction for a three-electrode system is relatively limited. Furthermore experiments have shown that production of double sided foils is not straightforward for a number of different reasons depending on the deposition method chosen.

If the electrode assembly is disposed using a printing technique, aligned double sided prints are not easily achieved due to the nature of the printing process.

If the electrode assembly is formed by etching deposited continuous metal films (thin film technology) it is typically a problem that foils having a suitable metallization on both sides are not readily available. Furthermore, the subsequent electrochemical modification of the different electrodes has proven to be very complex.

### OBJECT AND SUMMARY OF THE INVENTION

It is an object of the present invention to provide a method of producing an electrode assembly and to provide an electrode assembly that solves the above-mentioned shortcomings of the prior art.

Further, it is an object of the present invention to provide a method of producing an electrode assembly enabling a reduction of the width of the electrode assembly and to provide an electrode assembly having a reduced width.

An additional object of the invention to provide a method of producing an electrode assembly enabling a reduction of the width of the electrode assembly for a sensor without the problems normally associated with double sided deposition.

A further object of the invention is to more efficiently use the surface of the sensor tip.

A still further object of the invention is to enable an improved signal-to-noise ratio for an electrode.

A still further object of the invention is to provide small electrochemical sensors manufactured using simple and efficient screen-printing technology.

Another object of the present invention is to provide an electrode assembly comprising at least two conducting layers manufactured using a simple lamination technique.

Another object is to provide an electrode assembly comprising at least two conducting layers using an alternative way of applying dielectric material than using print technique but maintaining at least some of the same advantages.

A further object in relation to lamination of an electrode assembly comprising at least two conducting layers is to enable thin-film technology and to access a different range of polymers compared to using a screen printing technique.

A still further object of the invention is to provide an electrode assembly comprised in a sensor that reduces the pain and tissue damage when the sensor is inserted into the skin.

Another object is to provide an electrode assembly having an electrode surface (ES) large relative to the electrode width, whereby it is suitable for use in a transcutaneous in-vivo sensor.

Yet another object is to provide an electrochemical sensor comprising an electrode assembly according to the present invention.

These objects (among others) are obtained by an electrode assembly for use in a transcutaneous electrochemical sensor comprising at least a first conducting layer, at least a second conducting layer and at least a first dielectric layer wherein the first conducting layer is deposited on a substrate and that the first dielectric layer is placed between the first and the second conducting layer.

In this way, a more efficiently use the surface of the sensor tip is obtained, since the electrode surfaces (ESs) are deposited on top of the connector tracks instead of next to the connector tracks.

Further, a relatively larger active electrode area is provided thereby giving better quality sensor signals (and improved signal-to-noise ratio).

Additionally, production of small electrochemical sensors using simple and efficient screen-printing technology is provided, which also enables a small size thick film electrode (being relatively cheap to manufacture) that is comparable in size with high cost thin-film electrodes.

The object of the invention is accomplished by modification of conventional 2D structures into sandwiched or 3D structures containing at least two separated conductive layers. This is accomplished by sequential application of further layers constituting at least one dielectric layer and one further conducting layer to the original 2D structure. The dielectric layer may be applied first, followed by the application of a further electrical conducting layer. Alternatively the conventional 2D layer may be modified by lamination of a further 2D layer, thus forming a sandwiched structure.

The layers (both conducting and dielectric) are applied so that the ES(s) and contact areas (CPE(s)) of previously applied layers are not obstructed. In this way, an electrode assembly can be produced comprising alternating conducting layers and alternating dielectric layers; one of each layer for each electrode of the assembly.

In this way, a 3D or ‘SANDWICH’ type structure for an electrode assembly (e.g. for an electrochemical sensor) having a narrow/compact shape is obtained using a simple, cheap and efficient 2D application techniques (e.g. a printing process).

Alternatively the conventional 2D layer may be modified by lamination of a further 2D layer, thus forming a sandwiched structure.

In a preferred embodiment, the first conducting layer comprises a first electrode surface and a first contact area, the second conducting layer comprises a second electrode surface and a second contact area, and the first dielectric layer is adjacent to said first conductive layer and to said second conductive layer and do not cover the first electrode surface and the first contact area.

In an alternative preferred embodiment, the first conducting layer comprises a first electrode surface and a first contact area, the second conducting layer comprises a second electrode surface and a second contact area, and the first dielectric layer is adjacent to said substrate and to second conductive layer and do not cover the first electrode surface and the first contact area.

This embodiment enables the use of both thick film and thin film technology for placing the conducting structures. In addition, it increases the area were electrodes can be disposed, which may be very useful in some instances where an extra large electrode is needed or preferred, as this electrode then can be placed on the opposite side, and if extra electrodes are needed (e.g. for temperature measurements, differential measurements and/or other purposes) these can be placed on the opposite side.

In one embodiment, the electrode assembly further comprises a second dielectric layer where said second dielectric layer is adjacent to said second conductive layer and do not cover the first and second electrode surface and the first and second contact area.

In an alternative embodiment, the electrode assembly further comprises a second dielectric layer where said second dielectric layer is adjacent to said first conductive layer and do not cover the first electrode surface and the first contact area.

In one embodiment, the electrode assembly further comprises: a third conductive layer comprising a third electrode surface and a third contact area, and a third dielectric layer where said third dielectric layer is adjacent to said third conductive layer, that do not cover the first, the second and the third electrode surface and that do not cover the first, the second and the third contact area.

Hereby, a three-electrode system electrode assembly is obtained.

In one embodiment, said third conductive layer is adjacent to said second dielectric layer.

In one embodiment, the electrode assembly further comprises a fourth dielectric layer where said fourth dielectric layer is adjacent to said second conductive layer.

In one embodiment, the electrode assembly further comprises one or more additional conductive layer comprising an additional electrode surface and an additional contact area, and zero or more additional dielectric layer where said additional dielectric layer is adjacent to said additional conductive layer and do not cover any other electrode surface(s) of said electrode assembly and do not cover any other contact area(s) of said electrode assembly, where the number of additional conductive layers is equal to or one greater than the number of additional dielectric layers.

In one embodiment, the first and/or the second and/or the third conducting layer is/are made using a printing technique.

In this way, an easy and cheap way of manufacturing the electrode assembly is provided.

In one embodiment, the used printing technique is a screen printing technique or an ink-jet printing technique.

In one embodiment, the print technique uses print inks that contains: at least 50 weight percent (wt %), before curing, Pt, and/or at least 30 weight percent (wt %), before curing, carbon particles, and/or at least 30 weight percent (wt %), before curing, Ag, either as metal or as a halide hereof.

It is to be understood that the conducting layers may be made using the same ink or different inks of the above mentioned.

In one embodiment, the first and/or the second and/or the third dielectric layer is/are made using a screen printing technique.

In one embodiment, said first and/or said second and/or said third conductive layer is/are formed by etching continuous coats comprising Au or Ag or Cu or Al or InSnO.

In one embodiment, said first conductive layer is formed by etching continuous coats comprising Au or Ag or Cu or Al or InSnO and subsequent layer(s) is/are formed by printing.

In one embodiment, said first and said second conductive layers are formed by etching continuous coats comprising Au or Ag or Cu or Al or InSnO and subsequent layer(s) is/are formed by printing.

In one embodiment, the Au or Ag or Cu or Al or InSnO of each conductive layer is further plated with Pt or Au or Ag on at least the area of the conductive layer that is the electrode surface.

In this way, better electrochemical properties of the electrode surfaces are achieved.

In one embodiment, the first conductive layer is formed by laser ablation of a continuous coat of printed Pt, carbon or Ag.

In one embodiment, the dielectric substrate is a flexible material.

In one embodiment, the flexible material is made from polymeric material.

In one embodiment, said dielectric substrate is made from polyimide or polyester or polysulphone or polyphenylsulphone or polyetherimide or polymethylpentene or polycarbonate or polyurethane or mixtures thereof.

In one embodiment, said first dielectric layer and/or said second dielectric layer and/or said third dielectric layer comprise(s) a curable polymer.

In one embodiment, said first dielectric layer and/or said second dielectric layer and/or said third dielectric layer comprise(s) a polymer containing at least 5 weight percent (wt %) of an epoxy resin based on bis-phenol A or bis-phenol F or a mixture hereof.

In one embodiment, said first dielectric layer and/or said second dielectric layer and/or said third dielectric layer and/or said additional layer each is a laminate of at least two polymers.

In one embodiment, the polymer of two polymers of a given added laminate that is furthest away from said dielectric substrate is selected among the group of polyimides, polyesters, polysulphones, polyphenylsulphones, polyetherimides, polymethylpentenes, polycarbonates or blends containing at least 50 weight percent (wt %) hereof. Such polymers act as a stable substrate, thereby stabilizing the electrode assembly.

In one embodiment, the polymer of two polymers of a given laminate that is closest to the dielectric substrate is a thermoplastic material selected among the group of polyurethanes or acrylates or polyolefines or a mixture containing at least 50 weight percent (wt %) hereof. Such polymers act as glue, thereby enabling lamination.

In one embodiment, the polymer of two polymers of a given laminate that is closest to the dielectric substrate is a curable material, preferably an epoxy.

In one embodiment, the polymer of two polymers of a given laminate that is closest to the dielectric substrate has a melting point below the melting point of the dielectric substrate and below the melting point of the polymer of two polymers of a given added laminate that is furthest away from said dielectric substrate.

In one embodiment, the first dielectric layer is a laminate of at least two polymers, where the laminate comprises a conducting structure thus forming the second conducting layer.

In one embodiment, at least one conductive layer comprising an electrode surface and a contact area is a working electrode and that at least one conductive layer comprising an electrode surface and a contact area is a reference electrode.

In one embodiment, at least one conductive layer comprising an electrode surface and a contact area comprising Ag and AgCl.

Objects of the present invention are also achieved by an electrochemical sensor system comprising an electrode assembly according the present invention.

Objects of the present invention are also achieved by a method of manufacturing an electrode assembly, the method comprising the steps of: applying a first conductive layer to a dielectric substrate, the first conductive layer comprising a first electrode surface and a first contact area, applying a first dielectric layer to said first conductive layer so that said first electrode surface and said first contact area is not covered by said first dielectric layer, and applying a second conductive layer to said first dielectric layer so that said first electrode surface and said first contact area is not covered by said second conductive layer, said second conductive layer comprising a second electrode surface and a second contact area.

In one embodiment, the method further comprises the step of: applying a second dielectric layer to said second conductive layer so that said first and said second electrode surface and said first and said second contact area are not covered by said second dielectric layer.

In one embodiment, the method further comprises the steps of: applying a third conductive layer to said second dielectric layer so that said first and said second electrode surface and said first and said second contact area is not covered by said third conductive layer, said third conductive layer comprising a third electrode surface and a third contact area

In one embodiment, the method further comprises applying a third dielectric layer to said third conductive layer so that said first, second and third electrode surfaces and said first, second and third contact area is not covered by said third dielectric layer.

In one embodiment, the method further comprises the steps of: applying an additional conductive layer to the last applied dielectric layer so that already applied electrode surfaces and already applied contact areas is not covered by said additional conductive layer, said additional conductive layer comprising an additional electrode surface and an additional contact area, and applying an additional dielectric layer to said additional conductive layer so that already applied electrode surfaces and said additional electrode surface and said already applied contact area and said additional contact area are not covered by said additional dielectric layer, where the method further comprises repeating the above two steps until said electrode assembly comprises the preferred number of electrodes where the step of applying an additional dielectric layer may be omitted from the last repeating.

Objects of the present invention are also achieved by a method of manufacturing an electrode assembly, the method comprising the steps of: applying a first conductive layer to a dielectric substrate, applying a first polymer laminate comprising at least two polymers to said dielectric substrate, applying a second conductive layer to said first polymer laminate, and applying a second polymer laminate comprising at least two polymers to said first polymer laminate.

In one embodiment, the method comprises a step of: applying a first polymer laminate comprising at least two polymers and a second conductive layer to the dielectric substrate instead of comprising the steps of: applying a first polymer laminate comprising at least two polymers to said dielectric substrate, and applying a second conductive layer to said first polymer laminate.

Objects of the present invention are also achieved by a method of manufacturing an electrode assembly, the method comprising steps of: applying a first conductive layer comprising a first electrode surface and a first contact area, to a dielectric substrate on a first side of the dielectric substrate, applying a second conductive layer to a first dielectric layer, and applying the first dielectric layer to said dielectric substrate on a second side of the dielectric substrate.

In one embodiment, the method of manufacturing an electrode assembly further comprises: applying an additional dielectric layer on top of a conductive layer.

In one embodiment, the method comprises: applying the first dielectric layer by applying a first polymer laminate, and applying at least one additional dielectric layer using a printing technique. In this way one dielectric layer is a laminate while at least another may be made using the simple printing technique.

### BRIEF DESCRIPTION OF THE DRAWINGS

These and other aspects of the invention will be apparent from and elucidated with reference to the illustrative embodiments shown in the drawings, in which:

FIG. 1a schematically illustrates a top view of a (three-)electrode assembly/architecture according to one embodiment of the present invention;

FIG. 1b schematically illustrates a cross-sectional view along the horizontal broken line of FIG. 1a;

FIG. 2 schematically illustrates a stepwise preparation of one embodiment of an electrode assembly as illustrated in FIGS. 1a and 1b;

FIG. 3 schematically illustrates an electrode assembly for a three-electrode system according to an embodiment of the present invention;

FIG. 4 illustrate a prior art electrode arrangement for a three-electrode system using connectors using the same over-all area as in FIG. 3;

FIG. 5 illustrate an embodiment of a two-electrode sensor according to the present invention where a first (and a second) added dielectric layer is a laminate of at least two polymers;

FIG. 6 illustrate a cross section at line c in FIG. 5 of an embodiment (before and after assembly) where the first dielectric layer contains conducting structures forming the second conducting layer;

FIG. 7 illustrate a cross section at line c in FIG. 5 of an alternative embodiment than shown in FIG. 6, where the laminated dielectric and the second conducting layer are added separately;

FIG. 8 illustrate an embodiment (before and after assembly) of the present invention where two dielectric layers are placed adjacent to each other;

FIG. 9 illustrates a transcutaneous electrochemical sensor system suitable for in vivo measurement of metabolites.

Throughout the figures, same reference numerals indicate same, similar or corresponding features and/or structures.

### DESCRIPTION OF PREFERRED EMBODIMENTS

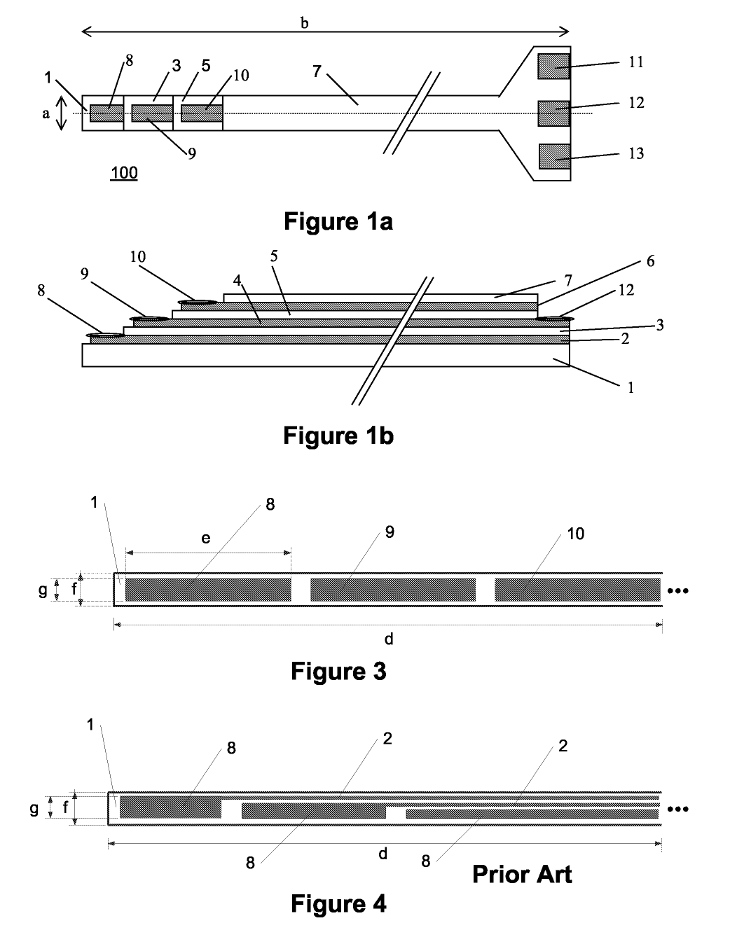

FIG. 1a schematically illustrates a top view of a (three-)electrode assembly/architecture according to one embodiment of the present invention. Shown is an electrode assembly (100) comprising a dielectric substrate (1), a first electrode surface (ES) (8) of a first conductive layer, a first dielectric layer (3), a second ES (9) of a second conductive layer, a second dielectric layer (5), a third ES (10) of a third conductive layer, a contact pad for electronics (CPE) (11) of the first conductive layer, a CPE (12) of the second conductive layer, a CPE (13) of the third conductive layer, and a third dielectric layer (7).

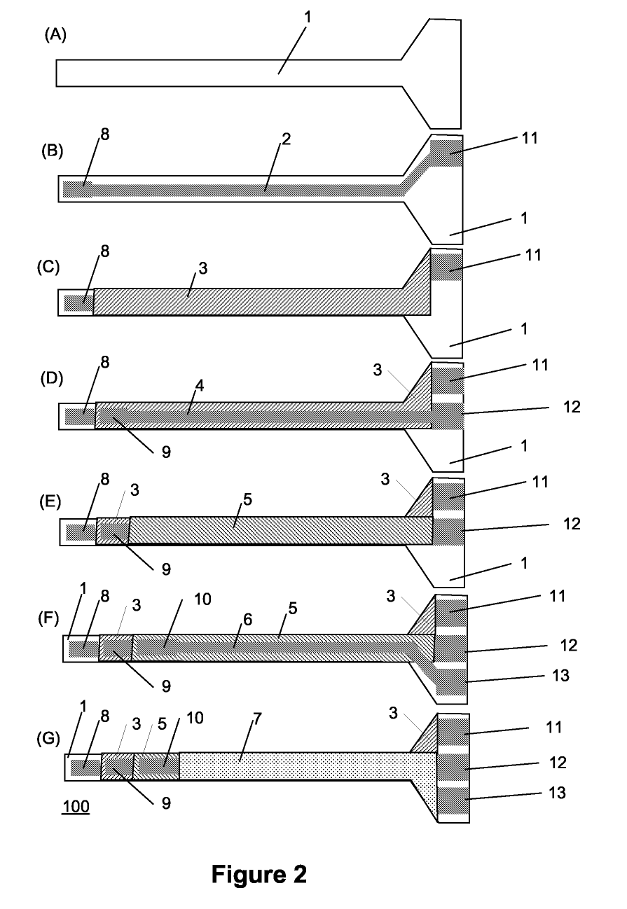

The first, second and third conductive layer is not shown specifically but is shown e.g. in FIGS. 1b and 2, as (2), (4) and (6), respectively.

A single electrode typically comprises a conductive layer comprising an ES, a CPE and a conductive track connecting the ES to the CPE. In the shown embodiment, electrical contact is preferably at the two ends of each conductive layer. The conductive track of a given electrode is covered with or adjacent to a layer of insulating (dielectric) material, i.e. the conductive layer is insulated except at the ends of the conductive layer, where an area of one end remains naked so electrical contact can be established to supporting electrical circuits, etc. and thereby function as the CPE, while an area at the other end also is left naked and thereby serves as the ES for later modification with sensor chemistry.

As mentioned, one of the electrodes of the electrode assembly (100) (i.e. one conductive layer with corresponding ES) can function as a working electrode (WE) while another electrode can function as a reference electrode (RE) and, if a three-electrode assembly, the last electrode may function as a counter electrode (CE).

In general, the embodiments of the present invention of an electrode assembly comprises two or more electrodes where the additional electrodes can be used as counter electrode (CE), for temperature measurements, differential measurements and/or other purposes.

In general, the invention is related to an electrode assembly comprising at least two electrodes, where at least one is a WE and one is a RE and/or a sensor comprising such an electrode assembly.

The shown electrode assembly (100) has a given length (b) and a given width (a), where it is important to minimize the width (a) to avoid or minimize tissue damage, possible formation of scar tissue, and/or unacceptable pain during insertion into the skin of a user. In one embodiment, the width (a) of the electrode assembly (or an electrochemical sensor comprising it) is typically 0.2-0.8 mm. Preferably, the width (a) is 0.3-0.5 mm. The length (b) is of less importance since the overall length by far is determined by the insertion system and what type of patch (being outside the body of a user) that the electrode assembly/sensor is connected to. The width (a) and/or the length (b) may vary depending on the actual application of the sensor.

The shown electrode assembly (100) according to the present invention has a very advantageous structure as will be described in greater detail in connection with FIG. 1b and in the following. Especially, is the width of the electrode/the electrode assembly (and thereby sensors that comprise such an assembly) smaller than other prior art thick film electrodes/electrode assemblies due to a stacking of electrodes/a 3D sandwich structure according to the present invention, which will be explained in greater detail in the following.

The shown electrode assembly enables a more efficiently use of the surface of a sensor tip comprising the assembly, since the ESs is deposited on top of the conductors instead of next to the conductor as is done according to prior art thereby enabling a smaller width of the sensor tip. Further, also since the ESs is deposited on top of the conductors, a larger active size/area of each ES is possible for the same size of sensor thereby giving an improved signal-to-noise ratio for each electrode as the use of a relatively larger active electrode area gives better sensor signals. These advantages are illustrated in connection with FIGS. 3 and 4.

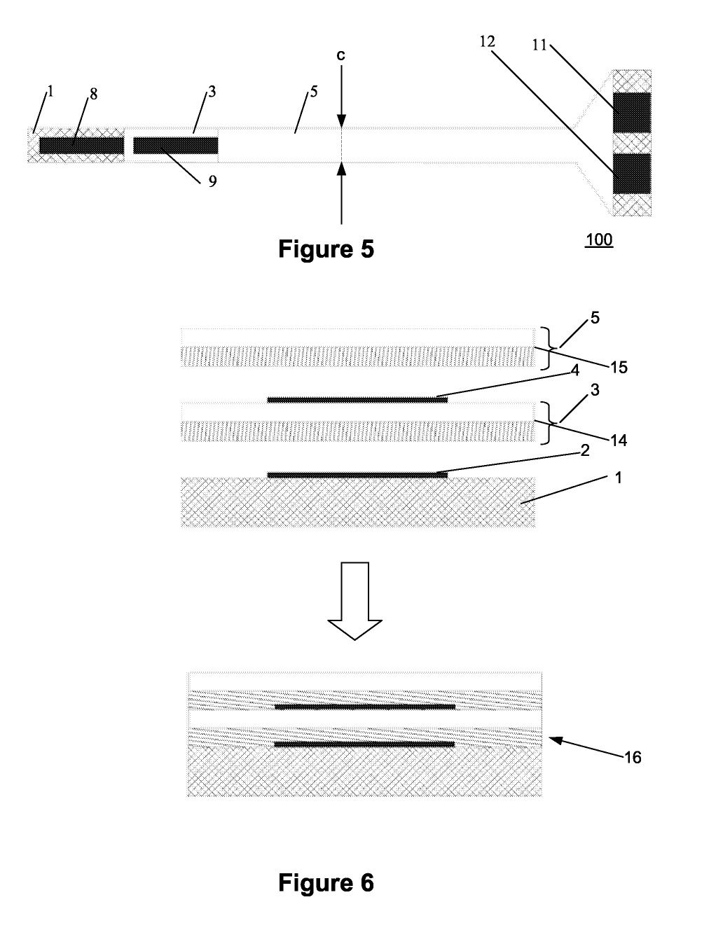

The structure and/or layout of an electrode assembly according to the invention also make it possible to produce small electrochemical sensors using simple and efficient screen-printing technology, as will be explained in greater detail in connection with FIG. 2 that illustrate a preferred way of producing or stacking this electrode assembly. An alternative way of producing electrode assemblies according to the present invention is to use lamination as explained in connection with FIGS. 5-8.

The shown form of the electrode assembly is not significant and may be adapted to suit a specific need. Examples are a generally L-shape, a generally I-shape (instead of the shown generally T-shape), round tracks, etc.

According to one preferred embodiment, the dielectric substrate (1) is flexible. In yet another preferred embodiment, the dielectric substrate (1) is polyimide, polyester, polysulphone, polyphenylsulphone, polyetherimide, polymethyl-pentene, polycarbonate or mixtures thereof. FIG. 1b schematically illustrates a cross-sectional view along the horizontal broken line of FIG. 1a. Shown is the electrode assembly (100) of FIG. 1b where the various conductive and dielectric layers are shown, thereby illustrating the stacking of electrodes, i.e. the 3D sandwich structure, according to the present invention.

The electrode assembly (100) comprises the dielectric substrate (1) which is adjacent to a first conductive layer (2) adjacent to a first dielectric layer (3) adjacent to a second conductive layer (4) adjacent to a second dielectric layer (5) adjacent to a third conductive layer (6) adjacent to the third dielectric layer (7).

In other words, the various layers are formed on top of each other alternating between a dielectric layer and a conductive layer. At the ends of a given conductive layer are areas exposed, i.e. without a dielectric layer part on the same side, thereby forming the CPE and ES of the electrode. The CPEs and ESs of the electrode assembly is, in this embodiment, exposed on the same side/in the same general direction.

Also illustrated in the figure, is the CPE (12) and the ES (9) of the second conductive layer (4), the ES (8) of the first conductive layer (2) and the ES (10) of the third conductive layer (6). The ESs and CPEs is the surface of the respective conductive layer that is for contact with the surroundings, as explained earlier.

Please note that the thicknesses of the layers are not shown in scale and are exaggerated for the sake of clarity.

Although the shown embodiment is a three-electrode assembly the principles of the present invention hold for a two-electrode assembly (see e.g. FIG. 5) and for three or more electrode assemblies.

FIG. 2 schematically illustrates a stepwise preparation of one embodiment of an electrode assembly as illustrated in FIGS. 1 a and 1 b. Shown is an electrode assembly after a number of steps (A)-(G), where each step illustrates the electrode assembly after a manufacturing step of a manufacturing process according to the present invention preferably using screen printing technique.

Figure (A) illustrates a dielectric substrate (1) (in any suitable form) that is used as a base for printing the other layers on according to the present invention. Usually, the electrode assemblies are printed on larger sheets of a dielectric substrate with several electrode assemblies on each. The substrate is then later cut by high precision machining to the desired shape, e.g. L-, T-, I- shape, etc. as mentioned earlier.

In Figure (B), the dielectric substrate (1) and a printed structure for a first electrode, i.e. a first conductive layer (2), is illustrated. The first conductive layer (2) comprises, as mentioned, areas at the ends that is used for a first ES (8) and a first CPE (11). This first conductive layer (2) is preferably printed on the dielectric substrate (1) using screen printing. The specific layout of the conductive layer may vary dependent on design and/or function.

Figure (C) illustrates the electrode assembly after insulation of first conductive layer (2) has been done by printing dielectric material in the form of a first dielectric layer (3). The first dielectric layer (3) is printed so that it covers the conductive layer (2) except for the areas that function as ES (8) and CPE (11).

Figure (D) illustrates the electrode assembly after a second conductive layer (4) (i.e. a second electrode) has been printed. The second conductive layer (4) is printed so that the ES (8) and the CPE (11) of the first conductive layer (2) are not obstructed from above/to one side by the second conductive layer (4).

In a preferred embodiment, the second conductive layer (4) is printed so that the second ES (9) is near or at least in the same end as the first ES (8). In addition, or in another preferred embodiment, the second conductive layer (4) is printed so that the second CPE (12) is near or at least in the same end as the first CPE (11).

Preferably, the ESs are placed substantially in one direction (i.e. in the direction of the needle/of insertion into the skin), which enables a thinner needle and thereby reduced pain to a user during insertion/placement. The CPEs may be placed substantially in the same direction or in a direction substantially perpendicular to the direction of insertion/the needle or variations thereof. The placement of the CPEs is generally not as crucial as the placement of the ECs, since it is not usually necessary to reduce the width of the area comprising the CPEs as it is to reduce the area comprising the ESs (although it can be done) since the CPEs normally are located outside the area of the sensor that is to go into the skin. The mentioned perpendicular arrangement of the CPEs enables easier connection with the relevant supporting electrical circuit(s). However, as mentioned previously, other forms, layouts, etc. are possible.

Figure (E) illustrates the electrode assembly after insulation of the second conductive layer (4) by printing a second dielectric layer (5) of a dielectric material. The second dielectric layer (5) is printed so that it covers the second conductive layer (4) except for the areas functioning as ES (9) and CPE (12) of this layer/electrode.

After this stage, the process could stop for a two-electrode assembly.

Figure (F) illustrates the electrode assembly after a third conductive layer (6) (i.e. a third electrode) has been printed. The third conductive layer (6) is printed so that the ES (9) and the CPE (12) of the second conductive layer (4) (as well as the ES (8) and CPE (11) of the first conductive layer) are not obstructed by the third conductive layer (6).

In preferred embodiments, the third conductive layer (6) is printed so that the third ES (10) is near or at least in the same end as the first ES (8) and/or the second ES (9). In addition, or in another preferred embodiment, the third conductive layer (6) is printed so that the third CPE (13) is near or at least in the same end as the first CPE (11) and/or the second CPE (12).

FIG. (G) illustrates the electrode assembly after insulation of the third conductive layer (6) by printing a third dielectric layer (7) of a dielectric material. The third dielectric layer (7) is printed so that it covers the third conductive layer (6) except for the areas functioning as ES (10) and CPE (13) of this layer/electrode.

After this stage, the process is in this example stopped as the produced electrode assembly (100) should be a three-electrode assembly.

For a 3+electrode assembly, steps of printing a conductive layer followed by printing a dielectric layer would follow until the wanted number of electrodes is reached.

In short, the manufacturing process is started with a dielectric base. After this one conducting layer and one dielectric layer are applied/printed for each electrode of the electrode assembly (100). The layers (both conducting and dielectric) are applied/printed so that the ES(s) and CPE(s) of previously applied/printed layers are not obstructed. In this way, an electrode assembly can be produced comprising alternating conducting layers and alternating dielectric layers; one of each layer for each electrode of the assembly.

In this way, a 3D or ‘SANDWICH’ type structure for an electrode assembly (e.g. for an electrochemical sensor) having a narrow/compact shape is obtained using a simple, cheap and efficient screen printing process.

Other sandwich structures for use as electrochemical sensors are known in the art (J. C. Ball et al. Anal. Chem 72 (2000) 497-501). However, these sandwich structures cannot be used as in-vivo sensors, since the conducting layers are fully covered by dielectric layers and a hole is laser drilled through the sandwich whereby only the small cross sections of the print can be used as electrodes, which gives a small electrode surface (ES) relative to the overall sensor size, instead of using the large ES that can be achieved with the sandwich structure according to the invention.

Preferably, print ink is used by the print technique, where the ink contains at least 50 weight percent (wt %), before curing, Pt, or at least 30 weight percent (wt %), before curing, carbon particles, or at least 30 weight percent (wt %), before curing, Ag, either as metal or as a halide hereof.

Alternatively, the first and/or the second and/or the third conductive layer (2; 4; 6) is/are formed by etching continuous coats comprising Au or Ag or Cu or Al or InSnO. Preferably, the Au or Ag or Cu or Al or InSnO of each conductive layer is further plated with Pt or Au or Ag on the area of the conductive layer that is the electrode surface.

As another alternative, the first conductive layer (2) on the dielectric substrate (1) is formed by laser ablation of a continuous coat of printed Pt or carbon or Ag, with the same weight percents as given above.

As a more specific and detailed example, a three-electrode sensor based on the invention can be constructed by printing a (conductive) layer Platinum (Pt) paste onto a foil sheet, e.g. of polyimide, polyester, polysulphone, polyphenylsulphone, polyetherimide, polymethyl-pentene, polycarbonate or mixtures thereof. The width of the electrode area (ES) and the connector (CPE) is e.g. 0.25 mm. Then the print is cured. A first dielectric paste layer is then printed onto the cured Pt; exposing 1.2 mm of the Pt print in the tip (where the width of the dielectric layer is 0.5 mm). The print is then cured once more. Then, a second (conductive) layer of Pt paste is printed onto the cured dielectric, with a distance of 0.2 mm to the previous Pt print. The width of the electrode area and the connector is again 0.25 mm. Then the print is cured. A second dielectric paste layer is then printed onto the second cured Pt; exposing 1.2 mm of the Pt print in the tip (the width of the dielectric layer being 0.5 mm). The print is then cured. Onto of the second dielectric layer, an Ag/AgCl paste is printed. The width of the electrode area and the connector was 0.25 mm. The print was then cured. A third dielectric paste layer was printed onto the cured Pt, exposing 1.2 mm of the Ag/AgCl print in the tip (the width of the dielectric layer being 0.5 mm). The print is then cured. On the distal end of the sensor the three contact pads had a dimension of 1.6 times 2.9 mm. The produced sensor can then be cut out from the foil sheet and be used as an electrochemical sensor. E.g. with the first Pt print used as working electrode, the second Pt print used as counter electrode, and the Ag/AgCl used as reference electrode.

FIG. 3 schematically illustrates an electrode assembly for a three-electrode system according to an embodiment of the present invention. Shown is a part of a three-electrode assembly that is used for being inserted into the skin of a user. The shown part of the assembly comprises a dielectric substrate (1) comprising a first, a second and a third electrode surface (ES) (8, 9, 10), respectively, corresponding to the ones explained above and in the following. The shown part has an indicated length ‘d’, which may vary according to design issues/decisions. An exemplary length ‘d’ is e.g. 5 mm. The shown part has an indicated width ‘f’, which also may vary. An exemplary width ‘f’ is 0.3 mm. Each ES has a length ‘e’, which may depend of various design issues/decisions. An exemplary length ‘e’ is e.g. 1.5 mm, but this may vary. Each ES has a width ‘g’, which also may depend of various design issues/decisions. An exemplary width ‘g’ is e.g. 0.2 mm. As mentioned the various sizes may vary and the above values merely serve as examples for illustrative purposes. Typically, the length ‘d’ is e.g. in the interval 3-8 mm, but may vary.

Typically, the width ‘f’ is e.g. in the interval 0.2-0.7 mm, but may vary. Typically, the length ‘e’ is e.g. in the interval 1.1-1.7 mm, but may vary. Typically, the width ‘g’ is e.g. in the interval 0.1-0.3 mm.

FIG. 4 illustrate a prior art electrode arrangement for a three-electrode system using connectors using the same over-all area as in FIG. 3 (length ‘d’ times width ‘f’). Shown is a part of a prior art three-electrode assembly that is used for being inserted into the skin of a user. The shown part of the assembly comprises a dielectric substrate (1) comprising a first, a second and a third electrode surface (ES) (8), respectively. However, these three ESs (8) are in a single conductive layer, but in separate structures. The shown part has an indicated length ‘d’ and width ‘f’, which are similar to the length ‘d’ and width ‘f’ of FIG. 3 enabling an easier comparison. The width ‘g’ corresponding to width ‘g’ of FIG. 3 is also illustrated giving an easier comparison. For illustrative purposes the dielectric layer covering the conductor tracks is not shown in the figure.

As mentioned, a problem with the present 2D technologies is that if the sensor should be narrow (which is preferred in order to reduce tissue damage and pain during insertion), the conductors down to the electrode areas (ESs) will take up valuable space on the limited area. As each electrode area (ES) has to become smaller due to the fact that some of the confined area has to be used for the conductive tracks (2), as can be seen in FIG. 4. According to the present invention, as e.g. shown in FIG. 3, the conductive tracks are located above/below each other in the 3D/sandwich type assembly of the present invention, thereby making it possible to use the entire space across the sensor/assembly for the ESs.

The provision of a larger active electrode area/surface (ES) relative to the overall sensor size, where the overall sensor size is the size of the part of the sensor that will be inserted into the skin of a user under use provides better sensor signals and an improved signal-to-noise ratio of the sensor.

Further, since the ES can be deposited on top of the conductors (between ES and CPE) instead of next to the conductor, a more efficiently use the surface of a sensor tip is enabled.

In short, compared to the prior art 2D assemblies, either improved signal-to-noise/better sensor signals are obtained while keeping the width of the part to be inserted or the same signal-to- noise ratio/same quality sensor signals are obtained but at a reduced width of the part to be inserted.

To achieve a good signal-to-noise ratio with a cost effective potentiostat an in-vivo amperometric glucose sensor working electrode should not be significantly smaller than 0.25 mm². To decrease the tissue damage and pain the sensor width ‘f’ should be about 0.3 mm and the length ‘d’ of the active area (housing all electrodes) maximum 5 mm. Using the 3D sandwich structure of the present invention for a three-electrode system with the same size on all sensors, the maximum electrode area that can be housed on the sensor is 0.3 mm² (0.05 mm left along the side, 0.1 mm on the tip and 0.2 mm between the electrodes) as illustrated in FIG. 3 giving the above values. When usual 2D electrode geometry is used it is not possible to make a three- electrode sensor when the line-and-space definition is 50 um (this width is common for many technologies). With a line-and-space definition of 40 um the electrode area can be 0.117 mm²; correspondingly 30 um gives 0.183 mm² as illustrated in FIG. 4 using the above values. To be close to the 0.25 mm², a line-and-space definition of less than 20 um is needed (20 μm gives 0.230 mm²) which requires quite expensive techniques during production.

In FIGS. 3 and 4 all three ESs on the electrode assembly are of same size, for simplicity and illustrative purposes. However the sizes may vary. For example, a two-electrode system may e.g. have dimensions that are different in the sense that the RE can be much bigger.

FIG. 5 illustrate an embodiment of a two-electrode sensor according to the present invention where a first (and a second) added dielectric layer is a laminate of at least two polymers. Shown is an electrode assembly (100) that is constructed according to a different embodiment of the present invention than according to FIG. 2.

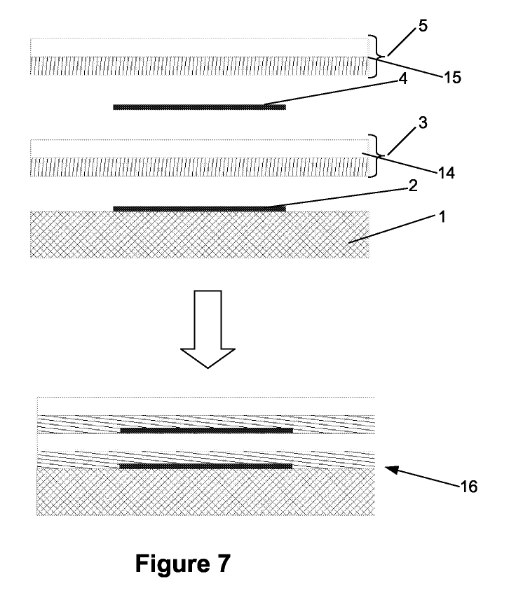

The shown (two-)electrode assembly (100) comprises a dielectric substrate (1), a first electrode surface (ES) (8) of a first conductive layer (not shown; see FIG. 6), a first dielectric layer (3), a second ES (9) of a second conductive layer (not shown; see FIG. 6), a second dielectric layer (5), a contact pad for electronics (CPE) (11) of the first conductive layer and a CPE (12) of the second conductive layer. These elements correspond to like elements explained in detail before but differ only in their way of being produced or manufactured according to another embodiment of the present invention. A three-electrode or (assembly comprising even further electrodes) would simply comprise more conductive layers with an ES and CPE and more dielectric layer (one of each for each electrode). Also shown is a line ‘c’ at which a cross section is shown in FIG. 6 according to one embodiment and in FIG. 7 according to another embodiment. The embodiment in FIGS. 5 (and 6 and 7) is an alternative electrode assembly, where a different way of applying dielectric parts than illustrated in FIG. 2 is used. Instead of printing the dielectric parts are laminated onto the conducting structures.

FIG. 6 illustrate a cross section at line c in FIG. 5 of an embodiment (before (top) and after (low) assembly) where the first dielectric layer (3) contains conducting structures forming the second conducting layer (4).

Shown is a dielectric substrate (1), with a first conductive layer (2) on it/adjacent to it.

In this embodiment, a first polymer laminate (14) forms the first dielectric layer (3) and also comprise a conducting structure forming the second conductive layer (4) located above the polymer laminate (14) away from the substrate (1), i.e. so the polymer laminate (14) is positioned between the first and second conductive layer. Also shown is a second laminate (15) of two polymers forming the second dielectric layer (5). During manufacture of the electrode assembly, the first conductive layer (2) is applied to the dielectric substrate (1) e.g. using screen printing, thin-film technologies, etc., then the first polymer laminate (14) (already comprising the second conductive layer (4)) is joined or added or stacked, etc. and finally the second laminate (15) is joined or stacked giving the assembled electrode assembly (16).

The use of this lamination process gives some advantages. In addition to using printing techniques it is possible to use thin-film technology, etc. This enables the use of thin metal films and other metals that are used within this technology area which gives more possibilities with respect to usable material than compared to screen printing. By using a lamination process to assemble the layers of the sandwich structure, the number of polymers that can be used as dielectric layer is increased since different types of polymers are used in the polymer laminate compared to what can be used in a screen printing technique, as explained in connection with FIG. 2.

Preferably, the polymer of the upper part of the laminate (14) forming the first dielectric layer (3) and of the laminate (15) forming the second dielectric layer (5) are chosen among polyimides or polyesters or blends containing at least 50 weight percent (wt %) hereof. Such polymers of the upper parts of the laminates (14, 15) acts as a stable substrate for the second conductive layers (4), as well as, stabilizing the electrode assembly.

Preferably, the polymer of the lower part of the laminate (14) forming the first dielectric layer (3) and of the lower part of the laminate (15) forming the second dielectric layer (5) are a thermoplastic material, preferably chosen among polyurethanes or acrylates or polyolefines or a mixture containing at least 50 weight percent (wt %) hereof. Such polymers of the lower parts of the laminates (14, 15) acts as glue, thereby enabling assembly of a sandwich structure by lamination.

FIG. 7 illustrate a cross section at line c in FIG. 5 of an alternative embodiment than shown in FIG. 6, where the laminated dielectric (14) and the second conducting layer (4) are added separately;

Shown is a dielectric substrate (1), with a first conductive layer (2) on it/adjacent to it. The first conductive layer (2) is e.g. screen printed on the substrate (1).

In this embodiment, a first polymer laminate (14) (preferably comprising two polymers) forms the first dielectric layer (3). However, in this embodiment (and therefore differing from the embodiment of FIG. 6) the first polymer laminate (14) do not comprise a conducting structure forming the second conductive layer (4). Rather, this second conductive layer (4) is added separately during manufacture.

Also shown is a second laminate (15) of two polymers forming the second dielectric layer (5). During manufacture of the electrode assembly, the first conductive layer (2) is printed onto the dielectric substrate (1), then the first polymer laminate (14) (not comprising the second conductive layer (4)) is joined or added or stacked, etc., then the second conductive layer (4) is added e.g. printed and finally the second laminate (15) is added giving the assembled electrode assembly (16).

The components and elements otherwise correspond to the ones explained in connection with FIG. 6 and earlier.

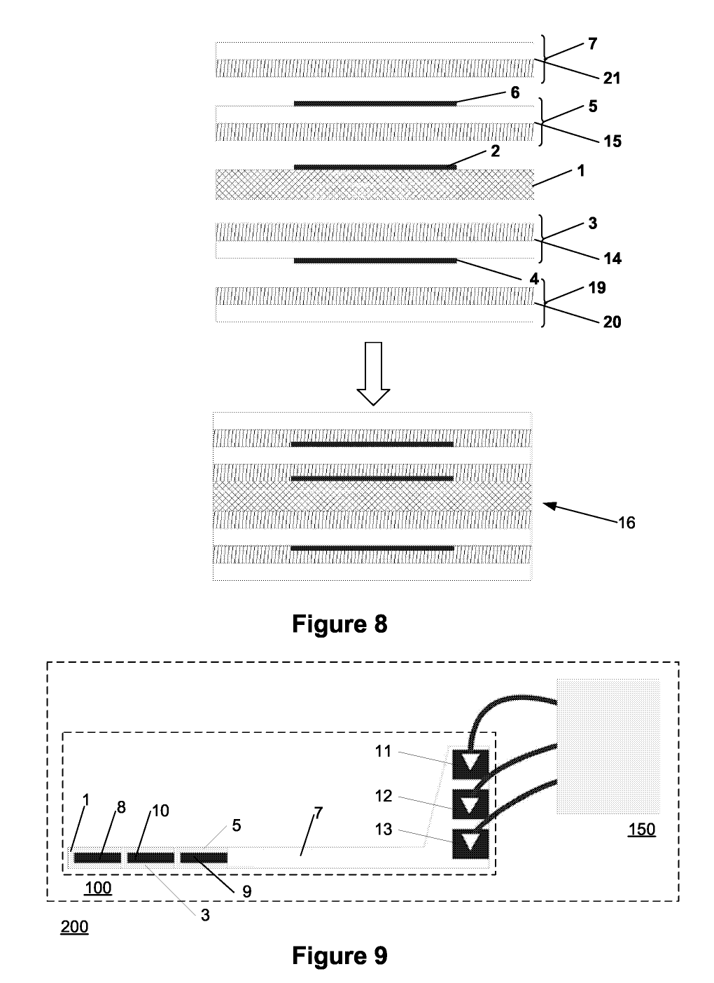

FIG. 8 illustrate an embodiment (before (top) and after (low) assembly) of the present invention where two dielectric layers are placed adjacent to each other.

This figure illustrates a three-electrode sensor made by lamination (as FIGS. 5-7 also are). Shown is a dielectric substrate (1) with a first conductive layer (2) e.g. printed on it. Also shown is a first laminate (14) comprising at least two polymers forming a first dielectric layer (3) and also comprising a second conductive layer (4). A second laminate (15) comprising at least two polymers forming a second dielectric layer (5) and also comprising a third conductive layer (6) is also shown. Further shown, is a third laminate (21) comprising at least two polymers that forms a third dielectric layer (7). Finally shown, is a fourth laminate (20) comprising at least two polymers forming a fourth dielectric layer (19). In this embodiment, the first dielectric layer (3) and the fourth dielectric layer (19) is form at one side of the dielectric substrate/base (1) while the second dielectric layer (5) and the third dielectric layer (7) is formed at the other side (also being the side comprising the first conductive layer (2); However, this layer (2) could be at the other side) resulting in an assembled electrode assembly (16).

This embodiment enables the use of both thick film and thin film technology for placing the conducting structures as is the case for the embodiments of FIGS. 5, 6 and 7. In addition, it increases the area were electrodes can be disposed, which may be very useful in some instances where an extra large electrode is needed or preferred, as this electrode then can be placed on the opposite side, and if extra electrodes are needed (e.g. for temperature measurements, differential measurements and/or other purposes) these can be placed on the opposite side.

Please note that the laminates and the dielectric and conductive layers according to the present invention do not necessarily have to be numbered or be applied according to the numbering as shown in the Figures.

FIG. 9 illustrates a transcutaneous electrochemical sensor system suitable for in vivo measurement of metabolites. Shown is a sensor system (200) comprising an electrode assembly (100) according to an embodiment of the present invention. The CPEs (11, 12, 13) is connected to electronics or a potentiostat (150) being well known in the prior art.

It is clear that the techniques mentioned in the text above can be mixed. Thus printed structures as well as etched structure can be modified by printing, lamination or a combination hereof.

Although the patent text for clarity only mentions electrode assemblies consisting of three-electrodes it is obvious that also electrode assemblies containing two electrodes or more than three electrodes in sandwich structure are covered by the patent.

1. An electrode assembly (100) for use in a transcutaneous electrochemical sensor comprising at least a first conducting layer (2), at least a second conducting layer (4) and at least a first dielectric layer (3) wherein that the first conducting layer (2) is deposited on a substrate (1) and that the first dielectric (3) layer is placed between the first (2) and the second conducting layer (4).

2. An electrode assembly according to claim 1, wherein
the first conducting layer (2) comprises a first electrode surface (8) and a first contact area(11),
the second conducting layer (4) comprises a second electrode surface (9) and a second contact area (12), and
the first dielectric layer (3) is adjacent to said first conductive layer (2) and to said second conductive layer (4) and do not cover the first electrode surface (8) and the first contact area (11).

3. An electrode assembly according to claim 1, wherein
the first conducting layer (2) comprises a first electrode surface (8) and a first contact area(11),
the second conducting layer (4) comprises a second electrode surface (9) and a second contact area (12), and
the first dielectric layer (3) is adjacent to said substrate (1) and to second conductive layer (4) and do not cover the first electrode surface (8) and the first contact area (11).

4. An electrode assembly according to claim 2, wherein the electrode assembly further comprises
a second dielectric layer (5) where said second dielectric layer (5) is adjacent to said second conductive layer (4) and do not cover the first (8) and second electrode surface (9) and the first (11) and second contact area (12).

5. An electrode assembly according to claim 3, wherein the electrode assembly further comprises
a second dielectric layer (5) where said second dielectric layer (5) is adjacent to said first conductive layer (2) and do not cover the first electrode surface (8) and the first contact area (11).

6. An electrode assembly according to claim 4, wherein said electrode assembly (100) further comprises:
a third conductive layer (6) comprising a third electrode surface (10) and a third contact area (13), and
a third dielectric layer (7) where said third dielectric layer (7) is adjacent to said third conductive layer (6), that do not cover the first (8), the second (9) and the third electrode surface (10) and that do not cover the first (11), the second (12) and the third contact area (13).

7. An electrode assembly according to claim 6, wherein said third conductive layer (6) is adjacent to said second dielectric layer (5).

8. An electrode assembly according to claim 3, wherein the electrode assembly (100) further comprises
a fourth dielectric layer (19) where said fourth dielectric layer (19) is adjacent to said second conductive layer (4).

9. An electrode assembly according to claim 1, wherein said electrode assembly (100) further comprises
one or more additional conductive layer comprising an additional electrode surface and an additional contact area, and
zero or more additional dielectric layer where said additional dielectric layer is adjacent to said additional conductive layer and do not cover any other electrode surface(s) of said electrode assembly and do not cover any other contact area(s) of said electrode assembly,
where the number of additional conductive layers is equal to or one greater than the number of additional dielectric layers.

10. An electrode assembly according to any one of claim 1, wherein the first and/or the second and/or the third conducting layer (2; 4; 6) is/are made using a printing technique.

11. An electrode assembly according to claim 10, wherein the used printing technique is a screen printing technique or an ink-jet printing technique.

12. An electrode assembly according to claim 11, wherein said print technique uses print inks that contain:
at least 50 weight percent (wt %), before curing, Pt, and/or
at least 30 weight percent (wt %), before curing, carbon particles, and/or
at least 30 weight percent (wt %), before curing, Ag, either as metal or as a halide hereof.

13. An electrode assembly according to any one of claim 1, wherein the first and/or the second and/or the third dielectric layer (3; 5; 7) is/are made using a screen printing technique.

14. An electrode assembly according to any one of claim 1, wherein said first and/or said second and/or said third conductive layer (2; 4; 6) is/are formed by etching continuous coats comprising Au or Ag or Cu or Al or InSnO.

15. An electrode assembly according to any one of claim 1, wherein said first conductive layer is formed by etching continuous coats comprising Au or Ag or Cu or Al or InSnO and subsequent layer(s) is/are formed by printing.

16. An electrode assembly according to any one of claim 1, wherein said first and said second conductive layers are formed by etching continuous coats comprising Au or Ag or Cu or Al or InSnO and subsequent layer(s) is/are formed by printing.

17. An electrode assembly according to any one of claim 14, wherein the Au or Ag or Cu or Al or InSnO of each conductive layer (2; 4; 6) is further plated with Pt or Au or Ag on at least the area of the conductive layer that is the electrode surface (8, 9, 10).

18. An electrode assembly according to any one of claim 1, wherein the first conductive layer (2) is formed by laser ablation of a continuous coat of printed Pt, carbon or Ag.

19. An electrode assembly according to any one of claim 1, wherein the dielectric substrate (1) is a flexible material.

20. An electrode assembly according to claim 1, wherein the flexible material is made from polymeric material.

21. An electrode assembly according to claim 1, wherein said dielectric substrate (1) is made from polyimide or polyester or polysulphone or polyphenylsulphone or polyetherimide or polymethylpentene or polycarbonate or polyurethane or mixtures thereof.

22. An electrode assembly according to any one of claim 1, wherein said first dielectric layer (3) and/or said second dielectric layer (5) and/or said third dielectric layer (7) comprise(s) a curable polymer

23. An electrode assembly according to claim 22, wherein said first dielectric layer (3) and/or said second dielectric layer (5) and/or said third dielectric layer (7) comprise(s) a polymer containing at least 5 weight percent (wt %) of an epoxy resin based on bis-phenol A or bis-phenol F or a mixture hereof.

24. An electrode assembly according to any one of claim 1, said first dielectric layer (3) and/or said second dielectric layer (5) and/or said third dielectric layer (7) and/or said additional layer each is a laminate (14; 15; 20; 21) of at least two polymers.

25. An electrode assembly according to claim 24, wherein the polymer of two polymers of a given added laminate (14; 15; 20; 21) that is furthest away from the dielectric substrate (1) is selected among the group of polyimides, polyesters, polysulphones, polyphenylsulphones, polyetherimides, polymethylpentenes, polycarbonates or blends containing at least 50 weight percent (wt %) hereof.

26. An electrode assembly according to any one of claim 24, wherein the polymer of two polymers of a given laminate (14; 15; 20; 21) that is closest to the dielectric substrate (1) is a thermoplastic material selected among the group of polyurethanes or acrylates or polyolefines or a mixture containing at least 50 weight percent (wt %) hereof.

27. An electrode assembly according to any one of claim 24, wherein the polymer of two polymers of a given laminate (14; 15; 20; 21) that is closest to the dielectric substrate (1) is a curable material, preferably an epoxy.

28. An electrode assembly according to claim 24, wherein the polymer of two polymers of a given laminate (14; 15; 20; 21) that is closest to the dielectric substrate has a melting point below the melting point of the dielectric substrate (1) and below the melting point of the polymer of two polymers of a given added laminate that is furthest away from said dielectric substrate.

29. An electrode assembly according to claim 24 wherein the first dielectric layer (3) is a laminate (14) of at least two polymers, where the laminate (14) comprises a conducting structure thus forming the second conducting layer (4).

30. An electrode assembly according to claim 1 wherein at least one conductive layer (2, 4, 6) comprising an electrode surface (8, 9, 10) and a contact area (11, 12, 13) is a working electrode and that at least one conductive layer (2, 4, 6) comprising an electrode surface (8, 9, 10) and a contact area (11, 12, 13) is a reference electrode.

31. An electrode assembly according to claim 1 wherein at least one conductive layer (2, 4, 6) comprising an electrode surface (8, 9, 10) and a contact area (11, 12, 13) comprising Ag and AgCl.

32. An electrochemical sensor system (200) comprising an electrode assembly according to claim 1.

33. A method of manufacturing an electrode assembly (100), the method comprising the steps of:
applying a first conductive layer (2) to a dielectric substrate (1), the first conductive layer (2) comprising a first electrode surface (8) and a first contact area (11),
applying a first dielectric layer (3) to said first conductive layer (2) so that said first electrode surface (8) and said first contact area (11) is not covered by said first dielectric layer (3), and
applying a second conductive layer (4) to said first dielectric layer (3) so that said first electrode surface (8) and said first contact area (11) is not covered by said second conductive layer (4), said second conductive layer (4) comprising a second electrode surface (9) and a second contact area (12).

34. A method according to claim 33, method further comprises the step of:
applying a second dielectric layer (5) to said second conductive layer (4) so that said first and said second electrode surface (8; 9) and said first and said second contact area (11; 12) are not covered by said second dielectric layer (5).

35. A method according to claims 33-34, the method further comprises the step of:
applying a third conductive layer (6) to said second dielectric layer (5) so that said first and said second electrode surface (8; 9) and said first and said second contact area (11; 12) is not covered by said third conductive layer (6), said third conductive layer (6) comprising a third electrode surface (9) and a third contact area (12).

36. A method according to claim 35, the method further comprises the step of:
applying a third dielectric layer (7) to said third conductive layer (6) so that said first, second and third electrode surfaces (8; 9; 10) and said first, second and third contact area (11; 12; 13) is not covered by said third dielectric layer (7).

37. A method according to claim 33, wherein the method further comprises the steps of:
applying an additional conductive layer to the last applied dielectric layer (5) so that already applied electrode surfaces (8; 9; 10) and already applied contact areas (11; 12; 13) is not covered by said additional conductive layer, said additional conductive layer comprising an additional electrode surface and an additional contact area, and
applying an additional dielectric layer to said additional conductive layer so that already applied electrode surfaces (8; 9; 10) and said additional electrode surface and said already applied contact area (11; 12; 13) and said additional contact area are not covered by said additional dielectric layer,
where the method further comprises repeating the above two steps until said electrode assembly (100) comprises the preferred number of electrodes where the step of applying an additional dielectric layer may be omitted from the last repeating.

38. A method of manufacturing an electrode assembly (100), the method comprising the steps of:
applying a first conductive layer (2) to a dielectric substrate (1),
applying a first polymer laminate (14) comprising at least two polymers to said dielectric substrate (1),
applying a second conductive layer (4) to said first polymer laminate (14), and
applying a second polymer laminate (15) comprising at least two polymers to said first conductive layer (2).

39. A method according to claim 38, wherein the method comprises a step of:
applying a first polymer laminate (14) comprising at least two polymers and a second conductive layer (4) to the dielectric substrate (1) instead of comprising the steps of:
applying a first polymer laminate (14) comprising at least two polymers to said dielectric substrate (1), and
applying a second conductive layer (4) to said first polymer laminate (14).

40. A method of manufacturing an electrode assembly, the method comprising the steps of:
applying a first conductive layer (2) comprising a first electrode surface (8) and a first contact area (11), to a dielectric substrate (1) on a first side of the dielectric substrate (1),
applying a second conductive layer (4) to a first dielectric layer (3), and
applying the first dielectric layer (3) to said dielectric substrate (1) on a second side of the dielectric substrate (1).

41. A method according to claim 37, wherein the method further comprises:
applying an additional dielectric layer (5, 7, 19) on top of a conductive layer (4, 6).

42. A method according to claim 38, wherein the method comprises:
applying the first dielectric layer (3) by applying a first polymer laminate (14), and
applying at least one additional dielectric layer (5, 7, 19) using a printing technique.
